(19) United States
(12) Patent Application Publication
(10) Pub. No.: US 2026/0211510 A1
(43) Pub. Date: Jul. 23, 2026

(54) NOTEBOOK COMPUTER AND KEYBOARD CONTROL METHOD THEREOF

(71) Applicant: ASUSTEK COMPUTER INC., TAIPEI (TW)

(72) Inventors: Shih-Chan CHIU, TAIPEI (TW); Yu-Ting CHEN, TAIPEI (TW); Zih-Siang HUANG, TAIPEI (TW); Liang-Jen LIN, TAIPEI (TW); Hung-Chieh WU, TAIPEI (TW); Yu-Sheng LIN, TAIPEI (TW); Wen-Ling HUANG, TAIPEI (TW); Wei-En CHEN, TAIPEI (TW)

(21) Appl. No.: 19/324,769

(22) Filed: Sep. 10, 2025

(30) Foreign Application Priority Data
Jan. 20, 2025 (TW) 114102329

(51) Int. Cl. G06F 3/02

(52) U.S. Cl. CPC G06F 3/0219; G06F 3/165; G06F 11/32; G06F 11/326

(57) ABSTRACT

A notebook computer adapted to execute a booting process and a conference program is provided. The notebook computer includes a keyboard module, light-emitting units and a light-emitting control unit. The keyboard module includes function keys arranged adjacently and corresponding to the conference program. The light-emitting control unit is adapted to control the light-emitting units to generate a first light effect in response to a first trigger event. The light-emitting control unit is also adapted to control the light-emitting units to generate a second light effect in response to a second trigger event. The second light effect is different from the first light effect. The first trigger event corresponds to an executing of the booting process via the notebook computer. The second trigger event corresponds to an event of launching the conference program via the notebook computer. A keyboard control method for the notebook computer is also provided.

### CROSS-REFERENCE TO RELATED APPLICATION

This application claims the priority benefit of Taiwan application serial No. 114102329, filed on Jan. 20, 2025. The entirety of the above-mentioned patent application is hereby incorporated by reference herein and made a part of the specification.

### BACKGROUND OF THE INVENTION

### Field of the Invention

The invention relates to a notebook computer and, more particularly, to a notebook computer adapted to a video conference and a keyboard control method thereof.

### Description of the Related Art

A conventional notebook keyboard usually does not include a microphone function key. Even some notebooks include the microphone function key, a position of the microphone function key is usually far away from that of a volume key. When the microphone or a volume of a speaker needs to be controlled during an online conference, a target key is not easily found among many function keys. Furthermore, other function keys are easily pressed by mistake.

### BRIEF SUMMARY OF THE INVENTION

A notebook computer is provided. The notebook computer is adapted to execute a booting process and a conference program. The notebook computer comprises: a keyboard module, including function keys arranged adjacently, the function keys configured corresponding to the conference program; light-emitting units, configured corresponding to the function keys; and a light-emitting control unit, electrically connected to the keyboard module and the light-emitting units, the light-emitting control unit is adapted to: control the light-emitting units to generate a first light effect in response to a first trigger event; and control the light-emitting units to generate a second light effect in response to a second trigger event, wherein the second light effect is different from the first light effect; the first trigger event corresponds to executing the booting process via the notebook computer, and the second trigger event corresponds to launching the conference program via the notebook computer.

A keyboard control method adapted to a notebook computer is provided. The notebook computer is adapted to execute a booting process and a conference program. The notebook computer includes a keyboard module and light-emitting units. The keyboard module includes function keys arranged adjacently. The function keys correspond to the conference program. The light-emitting units are configured corresponding to the function keys. The keyboard control method comprises: controlling the light-emitting units to generate a first light effect in response to a first trigger event; and controlling the light-emitting units to generate a second light effect in response to a second trigger event; wherein the first trigger event corresponds to executing the booting process via the notebook computer, and the second trigger event corresponds to launching the conference program via the notebook computer, and the second light effect is different from the first light effect.

In the notebook computer of embodiments in the invention, the keyboard module includes function keys arranged adjacently and corresponding to the conference program. When the conference program is launched, the function keys have light effects to remind users. In this way, it facilitates the users to control conference-related functions, such as a volume of a microphone or a speaker via the function keys during online conferences. Moreover, the probability of accidentally pressing the keys is reduced during the conference.

### BRIEF DESCRIPTION OF THE DRAWINGS

FIG. 1 is a block diagram showing a notebook computer according to an embodiment of the invention.

FIG. 2 is a schematic diagram showing a partial of a keyboard module according to a first embodiment of the invention.

FIG. 3A and FIG. 3B are schematic diagrams showing luminous changes of function keys shown in FIG. 2 according to an embodiment of the invention.

FIG. 4A and FIG. 4B are schematic diagrams showing luminous changes of function keys shown in FIG. 2 according to an embodiment of the invention.

FIG. 5 is a schematic diagram showing a partial of a keyboard module according to a second embodiment of the invention.

FIG. 6 is a schematic diagram showing a partial of a keyboard module according to a third embodiment of the invention.

FIG. 7 is a schematic diagram showing a partial of a keyboard module according to a fourth embodiment of the invention.

FIG. 8 is a flowchart of a keyboard control method according to an embodiment of the invention.

### DETAILED DESCRIPTION OF THE EMBODIMENTS

The embodiments of the invention are disclosed in detail accompanying following figures. Advantages and features of the application are clearer according to following descriptions and claims. The drawings are shown in a simplified form and imprecise proportions to conveniently and clearly assist to explain purposes of the embodiments.

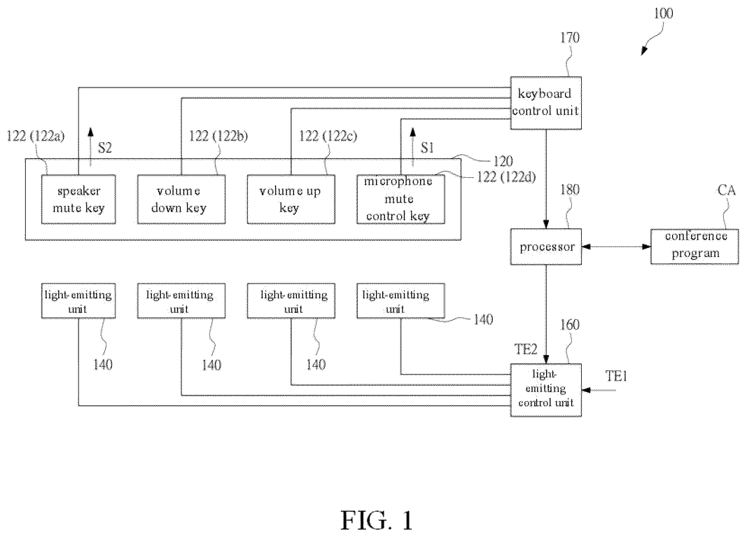

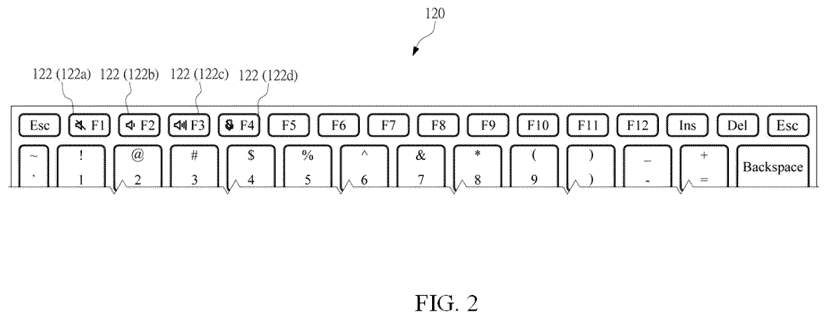

FIG. 1 is a block diagram showing a notebook computer 100 according to an embodiment of the invention. FIG. 2 is a schematic diagram showing a partial of a keyboard module 120 according to a first embodiment of the invention. The notebook computer 100 is adapted to execute a booting process and a conference program CA.

As shown in FIG. 1 and FIG. 2, the notebook computer 100 includes a keyboard module 120, a plurality of light-emitting units 140, a light-emitting control unit 160 and a processor 180.

The keyboard module 120 includes function keys 122 arranged adjacently. The function keys 122 correspond to the conference program CA. That is, the function keys 122 are commonly used during an execution process of the conference program CA. In an embodiment, the keyboard module 120 is a standard keyboard. The function keys 122 are configured at a top row of the standard keyboard, and the function keys 122 include the function keys F1 to F4. In an embodiment, the keyboard module 120 is a backlit keyboard. In an embodiment, the notebook computer 100 includes a keyboard control unit 170 adapted to receive key signals S1, S2 from the keyboard module 120.

In an embodiment, as shown in FIG. 2, the function keys 122 corresponding to the conference program CA include keys for video conferences, such as a speaker mute key 122a, a volume down key 122b, a volume up key 122c, and a microphone mute control key 122d, which is not limited herein. In an embodiment, the function keys 122 corresponding to the conference program CA include the speaker mute key 122a, the volume down key 122b, the volume up key 122c, the microphone mute control key 122d and a video control key (not shown).

The light-emitting units 140 are configured corresponding to the function keys 122. In an embodiment, the number of the light-emitting units 140 is the same as that of the function keys 122 corresponding to the conference program CA. Each light-emitting unit 140 is configured at a back of the corresponding function key 122. A key cap 1222 of the function key 122 is partially translucent. Consequently, the light from the light-emitting unit 140 is transmitted outwardly via a translucent part of the key cap 1222, which is not limited herein. In an embodiment, one function key 122 corresponds to a plurality of light-emitting units 140 with different lighting colors. In an embodiment, the function keys 122 corresponding to the conference program CA correspond to one light-emitting unit 140, and the light-emitting unit 140 is configured to remind setting positions of the function keys 122.

The light-emitting control unit 160 is electrically connected to the keyboard module 120 and the light-emitting units 140. The light-emitting control unit 160 controls the light-emitting units 140 to generate a first light effect in response to a first trigger event TE1. The first trigger event TE1 corresponds to an executing of the booting process via the notebook computer 100. In an embodiment, after the notebook computer 100 is powered on, a Basic Input Output System (BIOS) outputs a signal to notify the light-emitting control unit 160 to control the light-emitting units 140 to generate the first light effect. In an embodiment, the first light effect is a white-light effect.

The light-emitting control unit 160 also controls the light-emitting units 140 to generate a second light effect in response to a second trigger event TE2. The second light effect is different from the first light effect. The second trigger event TE2 corresponds to an event of launching the conference program CA via the notebook computer 100. In an embodiment, the conference program CA is a video conference program. In an embodiment, the light-emitting control unit 160 is a microcontroller.

The processor 180 is adapted to execute the conference program CA. The processor 180 notifies the light-emitting control unit 160 to generate the second light effect when the conference program CA is launched. In an embodiment, the processor 180 is a central processing unit (CPU). In an embodiment, the second light effect is a red-light effect, which is not limited herein. For example, in an embodiment, the first light effect is flashing light, and the second light effect is steady light. Moreover, in an embodiment, the first light effect is low-brightness light, and the second light effect is high-brightness light.

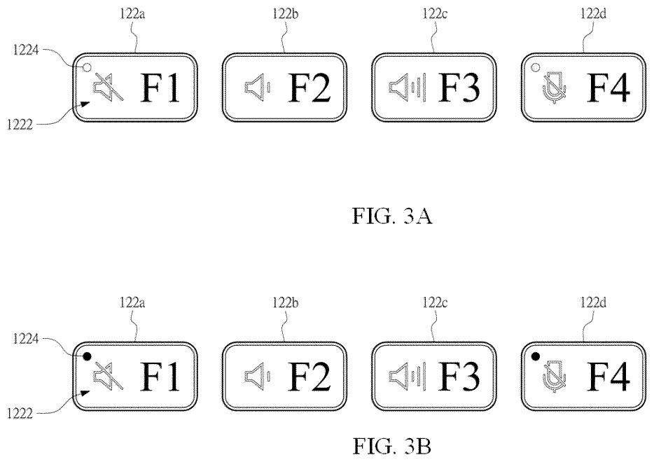

Please also refer to FIG. 3A and FIG. 3B. FIG. 3A and FIG. 3B are schematic diagrams showing luminous changes of function keys 122 shown in FIG. 2 according to an embodiment of the invention.

As shown in FIG. 3A and FIG. 3B, a keycap 1222 of at least one of the function keys 122 corresponding to the conference program CA includes a circular translucent area 1224. The circular translucent area 1224 is located at a corner of a surface of the keycap 1222 to avoid obscuring the pattern on the keycap 1222. After the conference program CA is launched, the circular translucent areas 1224 corresponding to the microphone mute control key 122d and the speaker mute key 122a become red (the second light effect as shown in FIG. 3B), while the circular translucent areas 1224 of other function keys 122 related to the conference program CA remain the original white-light effect (as shown in FIG. 3A).

As a result, during an online conference (when the conference program CA runs), a user intuitively identifies the positions and functions of the function keys 122 (such as functions of mute, volume down, volume up, microphone off) corresponding to the conference program CA via the second light effect. As a result, operations of the conference are easily controlled.

In an embodiment, please also refer to FIG. 1, after the microphone mute control key 122d is pressed, the light-emitting control unit 160 changes the color of the light-emitting unit 140 corresponding to the microphone mute control key 122d in response to a key signal S1 corresponding to the microphone mute control key 122d. Consequently, the color of the light-emitting unit 140 reminds the user of status of the microphone, which prevents the user from speaking continuously without realizing that the microphone is turned off. In an embodiment, the light-emitting unit 140 corresponding to the microphone mute control key 122d switches among colors. The colors include red and white. For example, white color is set to correspond to an on state of the microphone, and red color is set to correspond to an off state of the microphone. In an embodiment, the speaker is preset to the off state when the conference program CA runs.

In addition, after the speaker mute key 122a is pressed, the light-emitting control unit 160 controls to change the color of the light-emitting unit 140 corresponding to the speaker mute key 122a in response to the key signal S2 corresponding to the speaker mute key 122a, and then the state of the speaker is shown to the user. In an embodiment, the light-emitting unit 140 corresponding to the speaker mute key 122a switches among colors. The colors include red and white. For example, white color is set to correspond to an on state of the speaker, and red color is set to correspond to an off state of the speaker.

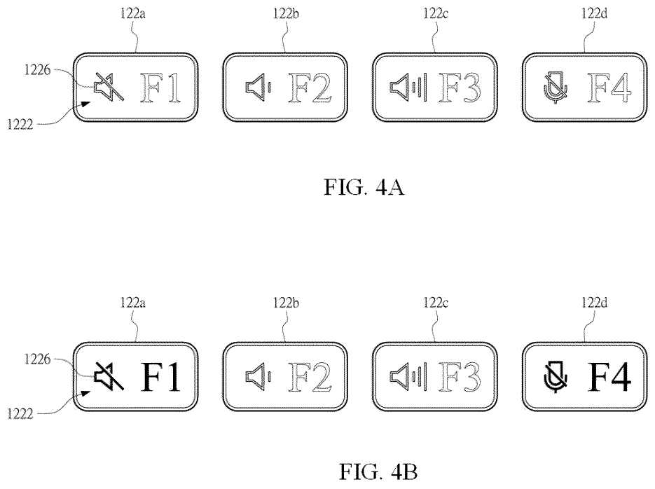

Please also refer to FIG. 4A and FIG. 4B. FIG. 4A and FIG. 4B are schematic diagrams showing luminous changes of function keys 122 shown in FIG. 2 according to an embodiment of the invention. The function keys 122 in this embodiment are adapted to a backlit keyboard.

As shown in FIG. 4A and FIG. 4B, light-transmitting patterns 1226 are formed on keycaps 1222 of the function keys 122 corresponding to the conference program CA. After the backlight of the keyboard module 120 is enabled, the light-transmitting patterns 1226 of the function keys 122 show the white light (that is, the first light effect shown in FIG. 4A).

After the conference program CA is launched, the color of the light-transmitting patterns 1226 corresponding to the microphone mute control key 122d and the speaker mute key 122a is changed to red (the second light effect shown in FIG. 4B), and the color of the light-transmitting patterns 1226 corresponding to other function keys 122 related to the conference program CA remains original white.

As a result, during an online conference (when the conference program CA runs), the user intuitively identifies the positions and functions of the function keys 122 (such as the functions of mute, volume down, volume up, microphone off) via the second light effect. As a result, operations of the conference are easily controlled.

Please also refer to FIG. 1, in an embodiment, after the microphone mute control key 122d is pressed, the light-emitting control unit 160 controls the light-emitting unit 140 corresponding to the microphone mute control key 122d to change the color in response to the key signal S1 corresponding to the microphone mute control key 122d. Consequently, the color of the light-emitting unit 140 reminds the user of the status of the microphone, which prevents the user from speaking continuously without realizing that the microphone is turned off. In an embodiment, the light-emitting unit 140 corresponding to the microphone mute control key 122d switches among colors. The colors include red and white. For example, white color is set to correspond to an on state of the microphone, and red color is set to correspond to an off state of the microphone. In an embodiment, the speaker is preset to the off state when the conference program CA runs.

In addition, after the speaker mute key 122a is pressed, the light-emitting control unit 160 controls the light-emitting unit 140 corresponding to the speaker mute key 122a to change the light color in response to the key signal S2 corresponding to the speaker mute key 122a, and then the state of the speaker is shown to the user to prevent the user from misjudging the status of the speaker and missing information during the conference. In an embodiment, the light-emitting unit 140 corresponding to the speaker mute key 122a switches among colors. The colors include red and white. For example, white color is set to correspond to an on state of the speaker, and red color is set to correspond to an off state of the speaker.

In the above embodiments, the light-emitting unit 140 is configured at the back of the corresponding function key 122 and transmits light outwardly via the partially translucent function key 122, which is not limited herein.

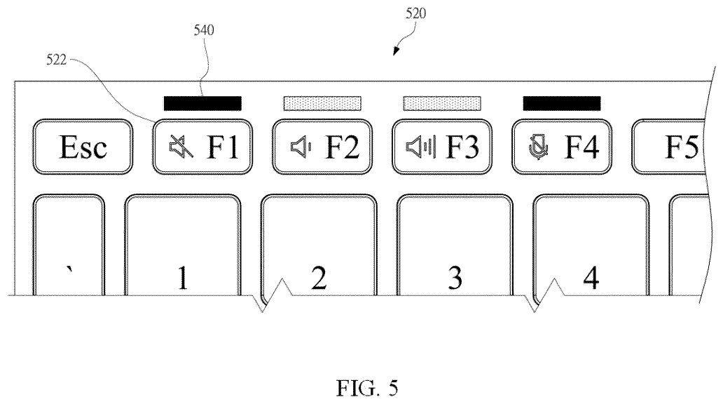

Please also refer to FIG. 5. FIG. 5 is a schematic diagram showing a partial of a keyboard module 520 according to a second embodiment of the invention. In the embodiment, light-emitting units 540 are located at a top edge of the keyboard module 520 and correspond to function keys 522 related to the conference program CA, respectively. The light-emitting units 540 are adapted to remind the user whether the function keys 522a are enabled and notify the user of the positions of the function keys 522.

In an embodiment, the luminous state of the light-emitting unit 540 is the same as that of the circular translucent area 1224 in FIG. 3A and FIG. 3B, which is not limited herein.

In the above embodiments in FIG. 3A to FIG. 5, the luminous state of the function keys 122 related to the conference program CA is changed to remind the user of the positions of the function keys 122, and the function keys 122 are distinguished from other keys on the keyboard module 120, which is not limited herein.

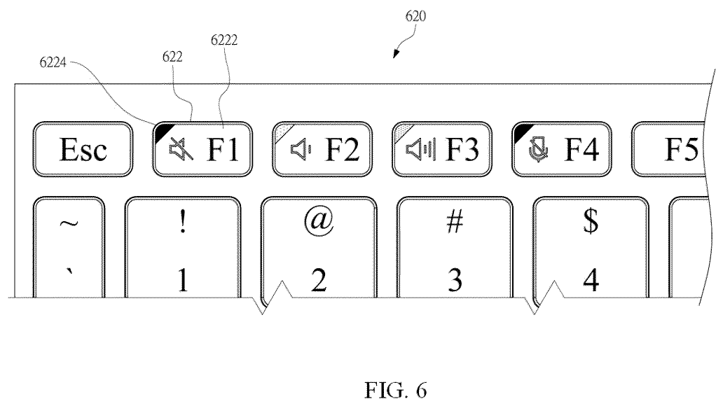

Please also refer to FIG. 6. FIG. 6 is a schematic diagram showing a partial of a keyboard module 620 according to a third embodiment of the invention.

In the embodiments of FIG. 3A to FIG. 4B, the positions and functional states of the function keys 122 related to the conference program CA are shown to remind users via changes of the luminous state. In contrast, in the embodiment in FIG. 6, a color mark 6224 is formed on the surface of a keycap 6222 of a function key 622 related to the conference program CA. The colors of the color marks 6224 of function keys 622 are different from each other, and then the user quickly distinguishes the functions of the function keys 622 easily.

In the embodiment, the color mark 6224 is formed at the corner of the surface of the keycap 6222 to avoid shielding the pattern on the function key 622, which is not limited herein. In an embodiment, the surface of the keycap 6222 is fully painted as the color mark 6224.

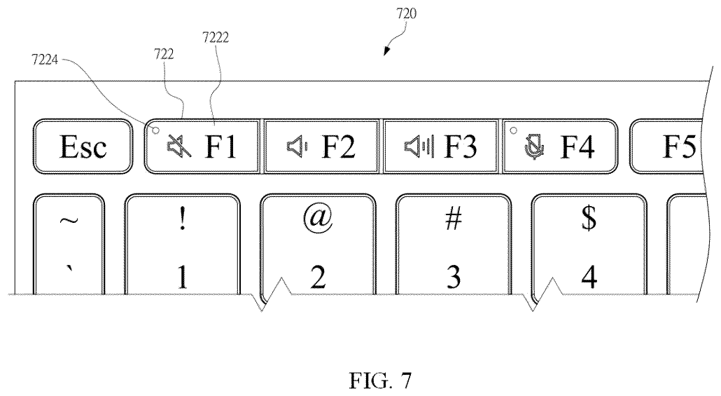

Please also refer to FIG. 7. FIG. 7 is a schematic diagram showing a partial of a keyboard module 720 according to a fourth embodiment of the invention.

In the embodiments in FIG. 3A to FIG. 4B, the positions and functional states of the function keys 122 related to the conference program CA are shown to remind the user via changes of the luminous state. As shown in FIG. 7, function keys 722 related to the conference program CA are arranged in a row to form a key area separated from other function keys of the keyboard module 720. Among the function keys 722 related to the conference program CA, a color mark 7224 is formed on the surface of a keycap 7222 of a beginning function key 722 and an end function key 722 in the row, respectively, to remind the user of the position (between two color marks 7224) of the function keys 722 related to the conference program CA on the keyboard module 720.

In the embodiment, the color mark 7224 is a dot formed at the corner of the surface of the keycap 7222, which is not limited herein. In an embodiment, the color mark 7224 is a line formed on a left or right edge of the keycap 7222.

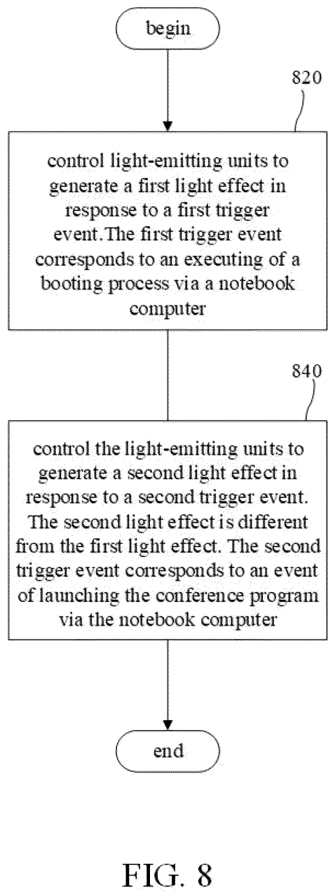

FIG. 8 is a flowchart of a keyboard control method according to an embodiment of the invention. The keyboard control method is adapted to the notebook computer 100 shown in FIG. 1 to FIG. 3. The notebook computer 100 is adapted to execute a booting process and a conference program CA. The notebook computer 100 includes a keyboard module 120 and a plurality of light-emitting units 140. The keyboard module 120 includes function keys 122 arranged adjacently. The function keys 122 correspond to the conference program CA. The light-emitting units 140 are arranged corresponding to the function keys 122, respectively. The keyboard control method includes the following steps.

In step S820, in response to a first trigger event TE1, the light-emitting units 140 are controlled to generate a first light effect. The first trigger event TE1 corresponds to an executing of the booting process via the notebook computer 100. In an embodiment, the step S820 is executed via the light-emitting control unit 160 in FIG. 1.

In step S840, in response to a second trigger event TE2, the light-emitting units 140 are controlled to generate a second light effect. The second light effect is different from the first light effect. The second trigger event TE2 corresponds to an event of launching the conference program CA via the notebook computer 100. The step S840 is executed via the processor 180 and the light-emitting control unit 160 in FIG. 1.

According to the notebook computers in the embodiments of the invention, the function keys corresponding to a conference program are configured adjacently at a keyboard module. When the conference program is launched, the function keys have a light effect to remind users. Consequently, users easily control conference-related functions, such as a volume of a microphone or a speaker via the function keys during online conferences. Moreover, the probability of accidentally pressing the keys is reduced during the conference.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A notebook computer, adapted to execute a booting process and a conference program, the notebook computer comprising:
a keyboard module, including function keys arranged adjacently, the function keys configured corresponding to the conference program;
light-emitting units, configured corresponding to the function keys; and
a light-emitting control unit, electrically connected to the keyboard module and the light-emitting units, wherein the light-emitting control unit is adapted to:
control the light-emitting units to generate a first light effect in response to a first trigger event; and
control the light-emitting units to generate a second light effect in response to a second trigger event, wherein the second light effect is different from the first light effect;
wherein the first trigger event corresponds to executing the booting process via the notebook computer, and the second trigger event corresponds to launching the conference program via the notebook computer.

2. The notebook computer according to claim 1, wherein the function keys include a speaker mute key, a volume down key, a volume up key and a microphone mute control key.

3. The notebook computer according to claim 2, wherein the light-emitting control unit is adapted to:
control the light-emitting unit corresponding to the microphone mute control key to change a light color in response to a key signal corresponding to the microphone mute control key.

4. The notebook computer according to claim 3, wherein the light-emitting unit corresponding to the microphone mute control key switches among a plurality of colors, and the colors include red and white.

5. The notebook computer according to claim 2, wherein the light-emitting control unit is adapted to:
control the light-emitting unit corresponding to the speaker mute control key to change a light color in response to a key signal corresponding to the speaker mute control key.

6. The notebook computer according to claim 5, wherein the light-emitting unit corresponding to the speaker mute key switches among a plurality of colors, and the colors include red and white.

7. The notebook computer according to claim 1, wherein the function keys include a speaker mute key, a volume down key, a volume up key, a microphone mute control key and a video control key.

8. The notebook computer according to claim 1, further including a processor adapted to execute the conference program and notify the light-emitting control unit to generate the second light effect when the conference program is launched.

9. The notebook computer according to claim 1, wherein a color mark is formed on a surface of a keycap of each of the function keys, respectively, and colors of the color marks on the function keys are different from each other.

10. The notebook computer according to claim 1, wherein the function keys are arranged in a row, and color marks are formed on surfaces of keycaps of two function keys at a beginning and an end of the row, respectively.

11. The notebook computer according to claim 1, wherein the light-emitting unit is configured at a back of the corresponding function key.

12. The notebook computer according to claim 11, wherein a keycap of the function key is partially translucent.

13. The notebook computer according to claim 1, wherein the keyboard module is a standard keyboard, the function keys are configured at a top row of the standard keyboard, and the light-emitting units are configured at a top edge of the standard keyboard.

14. The notebook computer according to claim 1, wherein the keyboard module is a backlit keyboard.

15. A keyboard control method, adapted to a notebook computer, the notebook computer is adapted to execute a booting process and a conference program, the notebook computer includes a keyboard module and light-emitting units, the keyboard module includes function keys arranged adjacently, the function keys correspond to the conference program, the light-emitting units are configured corresponding to the function keys, the keyboard control method comprising:
controlling the light-emitting units to generate a first light effect in response to a first trigger event; and
controlling the light-emitting units to generate a second light effect in response to a second trigger event;
wherein the first trigger event corresponds to executing the booting process via the notebook computer, and the second trigger event corresponds to launching the conference program via the notebook computer, and the second light effect is different from the first light effect.
